(19) United States
(12) Patent Application Publication
(10) Pub. No.: US 2013/0201519 A1
(43) Pub. Date: Aug. 8, 2013

(54) Bridging Non-Network Interfaces and Network Interfaces

(71) Applicants: Charles W. Duyk, Baltimore, MD (US); Michael R. Sweet, Morgan Hill, CA (US); James F. Lovell, Alameda, CA (US)

(72) Inventors: Charles W. Duyk, Baltimore, MD (US); Michael R. Sweet, Morgan Hill, CA (US); James F. Lovell, Alameda, CA (US)

(73) Assignee: APPLE INC., Cupertino, CA (US)

(21) Appl. No.: 13/616,105

(22) Filed: Sep. 14, 2012

Related U.S. Application Data
(60) Provisional application No. 61/594,543, filed on Feb. 3, 2012.

(51) Int. Cl. G06K 15/02

(52) U.S. Cl. 358/1.15

(57) ABSTRACT

The disclosed embodiments provide a system that facilitates the use of a device connected to a non-network interface. During operation, the system provides a bridge between the non-network interface and a network interface. Next, the system uses the bridge to enable communication with the device over the network interface. For example, the system may enable communication with a printer that is not configured for network printing over a network interface.

### RELATED APPLICATION

This application hereby claims priority under 35 U.S.C. §119 to U.S. Provisional Application No. 61/594,543, entitled “Bridging Non-Network Interfaces and Network Interfaces,” by Charles W. Duyk, Michael R. Sweet and James F. Lovell, filed 3 Feb. 2012.

### BACKGROUND

1. Field

The disclosed embodiments relate to interface bridges. More specifically, the disclosed embodiments relate to bridges between non-network interfaces and network interfaces for enabling communication with devices connected to the non-network interfaces over the network interfaces.

2. Related Art

Printers are often a problem for computer users. When a computer user initially installs a printer, the cabling and power cords are typically relatively straightforward to hook up. However, the user also has to install a printer-specific driver, which involves loading the driver from a disk and/or navigating to a website and downloading the driver. Even if the printer driver is already loaded into the computer system, the user may have to load and install an update for the driver from the printer manufacturer's website. Such installation operations are time-consuming and commonly require the user to find and enter a long software-license key. Moreover, additional installation operations may be required to configure a printer for network printing. As a result, users often skip such installation operations and access their printers via Universal Serial Bus (USB) and/or other non-network interfaces, even if the printers include networking functionality.

Printers pose an even bigger problem for users of portable electronic devices, such as laptop computers, tablet computers, portable media players, or smartphones. Such portable electronic devices are seldom configured with the requisite printer driver software. In addition, installing the appropriate printer driver can be bothersome, especially if the user of the portable electronic device only intends to use the nearby printer once or twice. Portable electronic devices may also have limited storage space, which makes it impractical for them to store a large number of printer drivers.

Hence, what is needed is a system that facilitates printing without the above-described problems.

### SUMMARY

The disclosed embodiments provide a system that facilitates the use of a device connected to a non-network interface. During operation, the system provides a bridge between the non-network interface and a network interface. Next, the system uses the bridge to enable communication with the device over the network interface. For example, the system may enable communication with a printer that is not configured for network printing over a network interface.

In some embodiments, providing the bridge between the non-network interface and the network interface involves querying, over the non-network interface, the printer for support for a printing protocol associated with the network interface over the non-network interface. If the printer supports the printing protocol over the non-network interface, the system initializes the bridge. For example, the system may initialize the bridge by executing a hardware and/or software component that opens a listening socket for data from clients associated with network connections over the network interface.

In some embodiments, providing the bridge between the non-network interface and the network interface further involves disabling the bridge if the printer is disconnected from the non-network interface.

In some embodiments, using the bridge to enable communication with the device over the network interface involves at least one of:
(i) using a discovery protocol to advertise a network-printing capability associated with the printer over the network interface;
(ii) mapping network connections from the network interface to the non-network interface; and
(iii) managing use of the printer over the network connections.

In some embodiments, using the discovery protocol to advertise the network-printing capability associated with the printer over the network interface involves providing a unique name for the printer for use by the discovery protocol. For example, the system may attempt to generate a unique name for the printer using the make and model of the printer. If the make and model are already registered on the discovery protocol (e.g., by another printer), the system may further generate the unique name by appending a serial number, username, and/or universally unique identifier (UUID) for the printer and/or a user associated with the printer to the make and model. The system may then provide the unique name for use by the discovery protocol, and the discovery protocol may advertise the network-printing capability for the printer by publishing the unique name and a specific service type and subtype.

In some embodiments, managing use of the printer over the network connections involves at least one of:
(i) arbitrating access to the printer by the network connections;
(ii) authenticating use of the printer by the network connections;
(iii) managing encryption of data transferred between the network connections and the printer; and
(iv) managing compression of data transferred between the network connections and the printer.

In some embodiments, arbitrating access to the printer by the network connections involves at least one of:
(i) mapping a network connection to an open interface of the non-network interface;
(ii) holding the network connection; and
(iii) closing the network connection.

In some embodiments, the non-network interface is a Universal Serial Bus (USB) interface.

### BRIEF DESCRIPTION OF THE DRAWINGS

FIG. 1 shows a schematic of a system in accordance with the disclosed embodiments.

FIG. 2 shows a system for facilitating the use of a device connected to a non-network interface in accordance with the disclosed embodiments.

FIG. 3 shows a flowchart illustrating the process of facilitating the use of a device connected to a non-network interface in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

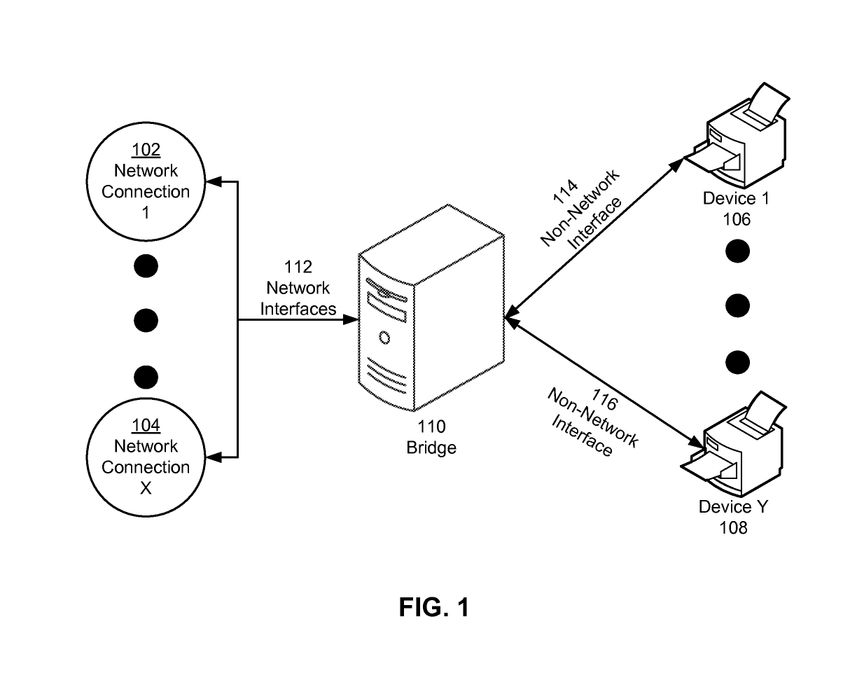

The disclosed embodiments facilitate communication with a device connected to a non-network interface. As shown in FIG. 1, a set of devices (e.g., device 1 106, device y 108) may be connected to a set of non-network interfaces 114-116. The devices may correspond to printers, digital cameras, portable media players, stereo systems, and/or other types of electronic devices. Non-network interfaces 114-116 may correspond to Universal Serial Bus (USB) interfaces, FireWire (FireWire™ is a registered trademark of Apple Inc.) interfaces, and/or other types of interfaces that do not utilize computer networks to transmit and receive data. As a result, the devices may only be capable of communication with computer systems connected directly to non-network interfaces 114-116.

To facilitate interaction with the devices from other computer systems (e.g., those not connected directly to the devices over non-network interfaces 114-116), non-network interfaces 114-116 may be used to connect a bridge 110 to the devices, and bridge 110 may be configured to enable communication with the devices over a set of network interfaces 112. For example, a set of network connections (e.g., network connection 1 102, network connection x 104) may be made through a set of wired and/or wireless network interfaces 112 to bridge 110. Bridge 110 may then map the network connections to non-network connections and/or communications over non-network interfaces 114-116.

In one or more embodiments, the devices correspond to printers that are not configured for network printing. Instead, the printers may be connected to bridge 110 using USB interfaces and support a printing protocol associated with network interfaces 112 over USB. As discussed in further detail below, bridge 110 may enable communication with the printers over network interfaces 112 by using a discovery protocol to advertise a driverless-printing service associated with the printers over network interfaces 112. Clients (e.g., computer systems) wishing to communicate with the printers may then establish the network connections using information obtained from the discovery protocol.

Once the network connections are made, bridge 110 may map the network connections from network interfaces 112 to non-network interfaces 114-116 and/or manage use of the printers over the network connections. For example, bridge 110 may arbitrate access to the printers by the network connections, authenticate use of the printers by the network connections, manage encryption of data transferred between the network connections and the printers, and/or manage compression of data transferred between the network connections and the printer. By facilitating communication among the clients and the printers, bridge 110 may increase both access to the printers by the clients and use of the printers by the clients.

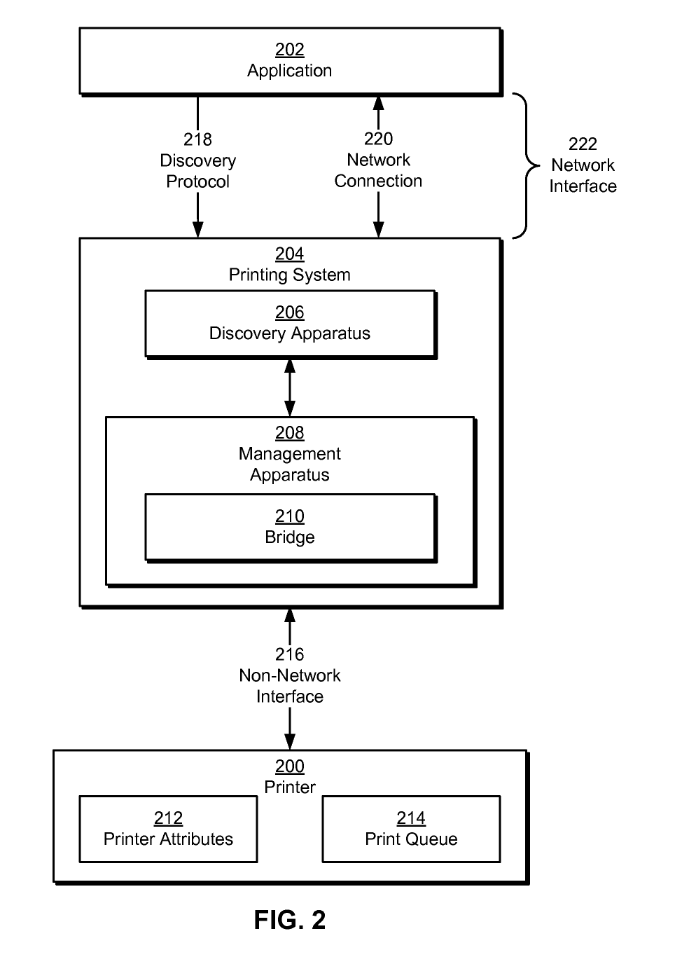

FIG. 2 shows a system for facilitating the use of a device connected to a non-network interface 216 in accordance with the disclosed embodiments. As described above, the device may be a printer 200 that is not configured for network printing. For example, printer 200 may not be set up for Transmission Control Protocol (TCP)/Internet Protocol (IP) communications over a wired and/or wireless computer network. Instead, printer 200 may be connected to a printing system 204 through a USB interface (e.g., non-network interface 216), and access to printer 200 from other computer systems may be conducted through printing system 204.

To facilitate the use of printer 200 by the other computer systems, printing system 204 may provide a bridge 210 between non-network interface 216 and a network interface 222. For example, an application 202 on a computer system may establish an Ethernet and/or WiFi connection with printing system 204 and send a print job over the Ethernet and/or WiFi connection to printing system 204. Bridge 210 may map the Ethernet and/or WiFi connection to communications and/or a connection over non-network interface 216, transmit the print job to printer 200 over non-network interface 216, and relay responses obtained from printer 200 over non-network interface 216 to application 202 over network interface 222.

More specifically, a management apparatus 208 in printing system 204 may set up bridge 210 by querying, over non-network interface 216, printer 200 for support for a printing protocol associated with network interface 222 over non-network interface 216. For example, management apparatus 208 may obtain a set of capabilities from printer 200 over a USB interface and examine the capabilities for a device string and/or protocol class associated with support for Internet Printing Protocol (IPP) over USB.

Management apparatus 208 may initialize bridge 210 if printer 200 supports the printing protocol. For example, management apparatus 208 may execute a hardware and/or software component that opens a listening socket on a TCP/IP interface (e.g., network interface 222) for data from clients such as application 202. Alternatively, management apparatus 208 may delay the initialization of bridge 210 until a request to connect to printer 200 is received from application 202 and/or another client over network interface 222. Management apparatus 208 may also disable bridge 210 if printer 200 does not support the printing protocol and/or is disconnected from non-network interface 216. Instead, management apparatus 208 may require application 202 and/or other clients to connect to printer 200 via a mechanism other than the printing protocol (e.g., print server, non-network interface 216, etc.).

Once bridge 210 is set up, management apparatus 208 may use bridge 210 to enable communication with printer 200 over network interface 222. First, management apparatus 208 may configure a discovery apparatus 206 in printing system 204 to advertise a network-printing capability associated with printer 200 and/or the printing protocol using a discovery protocol 218 such as Bonjour (Bonjour™ is a registered trademark of Apple Inc.) over network interface 222. Application 202 may then use information provided by discovery protocol 218 to discover printer 200 and establish a network connection 220 with bridge 210.

For example, management apparatus 208 may attempt to generate a unique name for printer 200 on discovery protocol 218 using the make and model of printer 200. If the make and model are already registered on discovery protocol 218 (e.g., by another printer), management apparatus 208 may further generate the unique name by appending a serial number, username, and/or universally unique identifier (UUID) for printer 200 and/or a user associated with printer 200 to the make and model. Next, management apparatus 208 may provide the unique name for use by discovery apparatus 206, and discovery apparatus 206 may advertise the network-printing capability for printer 200 on Bonjour and/or a cloud computing service by publishing the unique name and a specific service type and subtype.

Next, management apparatus 208 may enable use of limited resources over non-network interface 216 by mapping network connection 220 and/or other network connections from network interface 222 to non-network interface 216 and managing use of printer 200 over the network connections. For example, management apparatus 208 may manage access to two or more interfaces of a USB interface with printer 200 by using one of the interfaces as a control and/or monitoring channel and the remaining interface(s) for submitting print jobs received over the network connections.

To enable submission of print jobs to printer 200 over the network connections, management apparatus 208 may map each incoming network connection (e.g., network connection 220) to an open interface used for submitting print jobs by mapping network addresses associated with the network connection to device addresses associated with printer 200 on non-network interface 216. Once the network connection is mapped to an interface, management apparatus 208 may transmit the print job from the network connection to printer 200 over the interface. If printer 200 has sufficient memory (e.g., a print queue 214), management apparatus 208 may sequentially transmit other print jobs from the network connection and/or other network connections over the same interface to printer 200.

Conversely, if printer 200 can accept only one print job at a time and/or if no open interfaces are currently available, management apparatus 208 may hold incoming network connections until an interface is freed, close the network connections and force the clients associated with the network connections to retry, and/or temporarily stop accepting network connections. Management apparatus 208 may additionally prioritize access to printer 200 by managing a queue of network connections waiting for access to interfaces of non-network interface 216. In other words, management apparatus 208 may arbitrate access to limited resources associated with non-network interface 216 and printer 200 by the network connections.

Management apparatus 208 may further manage use of printer 200 by network connection 220 and/or other network connections by authenticating use of printer 200 by the network connections, managing encryption of data transferred between the network connections and printer 200, and/or managing compression of data transferred between the network connections and printer 200. For example, management apparatus 208 may use Kerberos authentication, challenge-response authentication, password authentication, and/or certificates to verify access rights to printer 200 by application 202 and/or other clients. Similarly, management apparatus 208 may require the encryption and/or compression of data sent over the network connections and decrypt and/or decompress the data prior to transmitting over non-network interface 216. Finally, if authentication and/or encryption are used by the network connections, management apparatus 208 may filter data received over the network connections to remove and/or change network headers (e.g., host headers) prior to transmitting the data over non-network interface 216.

By bridging non-network interface 216 and network interface 222, printing system 204 may facilitate use of printer 200 by network connection 220 and/or other network connections. In particular, printing system 204 may enable the discovery of printer 200 using a network-based discovery protocol 218, as well as the bridging of network connections (e.g., network connection 220) over network interface 222 to communications over non-network interface 216. Such bridging may further facilitate access to a limited resource (e.g., printer 200 and non-network interface 216) by multiple network connections, as well as the transmission of standardized information between clients associated with the network connections and printer 200 without requiring the installation of a driver for printer 200 on the clients.

For example, printing system 204 may receive a print job containing print data and job options from a client (e.g., application 202) over a network connection (e.g., network connection 220), format the print job for transmission over non-network interface 216, and transmit the print job to printer 200 over non-network interface 216. Printing system 204 may then receive a response from printer 200 containing a job identifier and/or a set of printer attributes 212 (e.g., printer status, printer capabilities, etc.) for the print job and relay the response over the network connection to the client. Any changes or cancellations to the print job may also be requested by the client over network interface 222 and carried out immediately by printing system 204 using the control interface of non-network interface 216.

On the other hand, the lack of bridge 210 in a conventional print server may prevent the clients from fully communicating with printer 200. Instead, a driver for printer 200 may be installed on each client printer 200, and print jobs may be transmitted as data streams from the clients to the print server without receiving confirmation of the print jobs and/or standardized status information associated with the print jobs from printer 200. Moreover, a delay may be experienced between a cancellation of a print job by a client and the actual termination of the print job by printer 200 (e.g., after printer 200 has run out of print data from the client).

Those skilled in the art will appreciate that the system of FIG. 2 may be implemented in a variety of ways. For example, discovery apparatus 206, management apparatus 208, and bridge 210 may be provided by the same software and/or hardware component, or discovery apparatus 206, management apparatus 208, and bridge 210 may execute independently from one another. Similarly, one or more components of printing system 204 may be implemented by a computer system, wireless base station, and/or other electronic device with functionality to communicate over both non-network interface 216 and network interface 222.

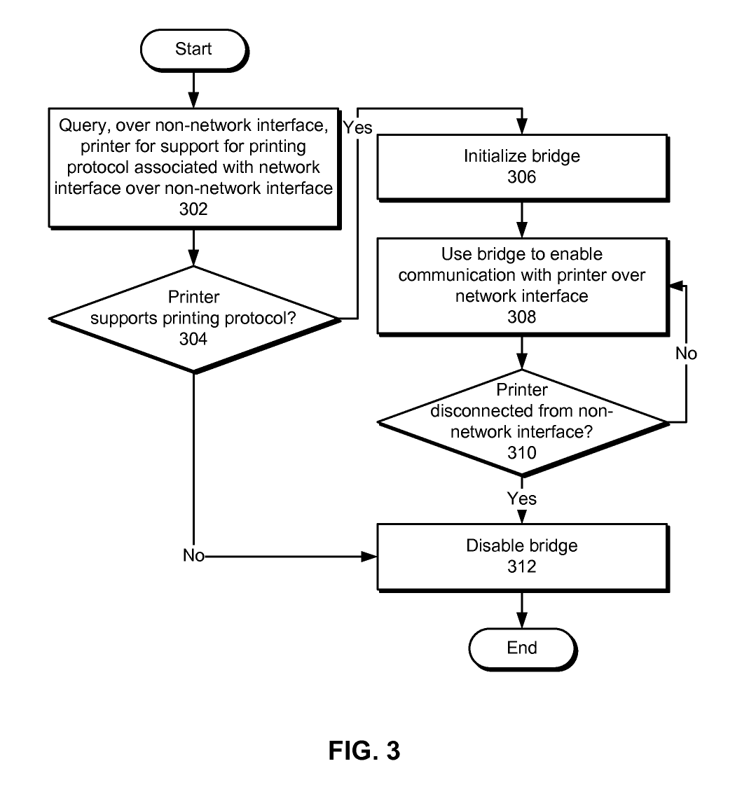

FIG. 3 shows a flowchart illustrating the process of facilitating the use of a device connected to a non-network interface in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

As mentioned above, a bridge between the non-network interface and a network interface may be provided to facilitate communication with the device. Moreover, the device may correspond to a printer, and the non-network interface may correspond to a USB interface. To facilitate use of the printer over the network interface, the printer is queried, over the non-network interface, for support for a printing protocol associated with the network interface over the non-network interface (operation 302), such as IPP over USB. The printer's response to the query may indicate support for the printing protocol (operation 304) or lack of support for the printing protocol. If the printer does not support the printing protocol, the bridge is disabled (operation 312), and communication with the printer may be conducted through a mechanism other than the printing protocol.

If the printer supports the printing protocol, the bridge is initialized (operation 306) and used to enable communication with the printer over the network interface (operation 308). For example, discovery of the printer over the network interface may be enabled by publishing a unique name for the printer, as well as a specific service type and subtype for the printing protocol, using a discovery protocol such as Bonjour. Once data is received from clients over the network interface, network connections associated with the clients may be mapped from the network interface to the non-network interface.

In addition, use of the printer over the network connections may be managed by arbitrating access to the printer by the network connections, authenticating use of the printer by the network connections, managing encryption of data transferred between the network connections and the printer, and/or managing compression of data transferred between the network connections and the printer. For example, access to the printer by multiple network connections may be arbitrated by mapping each network connection to an open interface of the non-network interface, holding the network connection, and/or closing the network connection and forcing the client associated with the network connection to retry.

The bridge may continue to be used (operation 308) based on the connection of the printer to the non-network interface (operation 310). If the printer remains connected to the non-network interface, communication with the printer over the network interface may continue to be enabled by the bridge. If the printer is disconnected from the non-network interface, the bridge is disabled (operation 312).

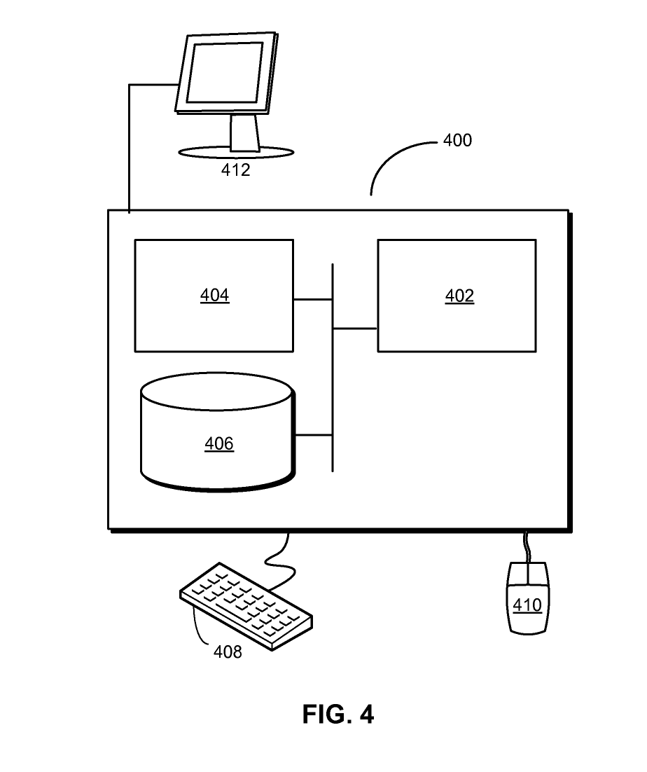

FIG. 4 shows a computer system 400 in accordance with the disclosed embodiments. Computer system 400 may correspond to an apparatus that includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for facilitating the use of a device (e.g., a printer) connected to a non-network interface (e.g., a USB interface). The system may include a bridge between the non-network interface and a network interface. The system may also include a management apparatus that uses the bridge to enable communication with the device over the network interface. For example, the management apparatus may enable network communications with a non-network-enabled printer by using a discovery protocol to advertise a network-printing capability associated with the printer over the network interface, mapping network connections from the network interface to the non-network interface, and/or managing access to the printer from the network connections.

In addition, one or more components of computer system 400 may be remotely located and connected to the other components over a network. Portions of the present embodiments (e.g., bridge, management apparatus, device, etc.) may also be located on different nodes of a distributed system that implements the embodiments. For example, the present embodiments may be implemented using a cloud-computing system that manages the operation of interface bridges to remote devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1-25. (canceled)

26. A non-transitory program storage device, readable by a processor and comprising instructions stored thereon to cause one or more processors to:
discover one or more first devices connected via one or more non-network connections to a bridge device;
determine that a first set of the one or more first devices support a communication protocol to facilitate communication with one or more second devices connected via one or more network connections to the bridge device;
publish a unique identifier for each of the first devices in the first set to the one or more second devices via the one or more network connections;
receive data directed to a selected one of the first devices in the first set from one of the second devices over one of the network connections; and
map the data to the selected first device over one of the non-network connections between the selected first device and the bridge device.

27. The non-transitory program storage device of claim 26, wherein the selected first device comprises a printer.

28. The non-transitory program storage device of claim 26, wherein the one or more non-network connections to the bridge device comprise at least one universal serial bus (USB) connection.

29. The non-transitory program storage device of claim 26, wherein the instructions to cause the one or more processors to determine that a first set of the one or more first devices support a communication protocol to facilitate communication with one or more second devices comprise instructions to cause the one or more processors to obtain a set of capabilities from each of the one or more first devices.

30. The non-transitory program storage device of claim 29, further comprising instructions to cause the one or more processors to examine the sets of capabilities for a device string or protocol class associated with support for the communication protocol.

31. The non-transitory program storage device of claim 30, wherein the communication protocol comprises an Internet Printing Protocol (IPP) over universal serial bus (USB).

32. The non-transitory program storage device of claim 26, wherein the instructions to cause the one or more processors to publish a unique identifier comprise instructions to cause the one or more processors to publish a unique identifier using a discovery protocol.

33. The non-transitory program storage device of claim 26, wherein the unique identifier for each of the first devices is generated based, at least in part, on a make and model of the first device.

34. The non-transitory program storage device of claim 26, wherein the instructions to cause the one or more processors to map the data to the selected first device comprise instructions to cause the one or more processors to manage encryption of the data.

35. The non-transitory program storage device of claim 26, wherein the instructions to cause the one or more processors to map the data to the selected first device comprise instructions to cause the one or more processors to manage compression of the data.

36. The non-transitory program storage device of claim 26, further comprising instructions to cause the one or more processors to disable the bridge device when it is determined that one or more of the first devices have been disconnected from the bridge device.

37. The non-transitory program storage device of claim 26, further comprising instructions to cause the one or more processors to arbitrate access to at least one of the one or more first devices by at least one of the one or more second devices.

38. The non-transitory program storage device of claim 37, wherein the instructions to cause the one or more processors to arbitrate access to at least one of the one or more first devices by at least one of the one or more second devices comprise instructions to cause the one or more processors to hold at least one of the network connections until an interface to the at least one of the first devices transitions from a not-available status to an available status.

39. A method, comprising:
discovering, by one or more processors, one or more first devices connected via one or more non-network connections to a bridge device;
determining, by the one or more processors, that a first set of the one or more first devices support a communication protocol to facilitate communication with one or more second devices connected via one or more network connections to the bridge device;
publishing, by the one or more processors, a unique identifier for each of the first devices in the first set to the one or more second devices via the one or more network connections;
receiving, by the one or more processors, data directed to a selected one of the first devices in the first set from one of the second devices over one of the network connections; and
mapping, by the one or more processors, the data to the selected first device over one of the non-network connections between the selected first device and the bridge device.

40. The method of claim 39, wherein the selected first device comprises a printer.

41. The method of claim 39, wherein the one or more non-network connections to the bridge device comprise at least one universal serial bus (USB) connection.

42. The method of claim 39, wherein at least one of the second devices comprises a portable electronic device.

43. A bridge device, comprising:
a memory; and
one or more processors coupled to the memory and adapted to execute program code stored in the memory to:
discover one or more first devices connected via one or more non-network connections to the bridge device;
determine that a first set of the one or more first devices support a communication protocol to facilitate communication with one or more second devices connected via one or more network connections to the bridge device;
publish a unique identifier for each of the first devices in the first set to the one or more second devices via the one or more network connections;
receive data directed to a selected one of the first devices in the first set from one of the second devices over one of the network connections; and
map the data to the selected first device over one of the non-network connections between the selected first device and the bridge device.

44. The bridge device of claim 43, wherein the program code to cause the one or more processors to determine that a first set of the one or more first devices support a communication protocol to facilitate communication with one or more second devices comprises program code to cause the one or more processors to obtain a set of capabilities from each of the one or more first devices.

45. The bridge device of claim 44, further comprising program code stored in the memory to cause the one or more processors to examine the sets of capabilities for a device string or protocol class associated with support for the communication protocol.

46. The bridge device of claim 45, wherein the communication protocol comprises an Internet Printing Protocol (IPP) over universal serial bus (USB).

47. The bridge device of claim 43, further comprising program code stored in the memory to cause the one or more processors to disable the bridge device when it is determined that one or more of the first devices have been disconnected from the bridge device.

48. The bridge device of claim 43, wherein the unique identifier for each of the first devices is generated based, at least in part, on a make and model of the first device.

49. The bridge device of claim 43, further comprising program code stored in the memory to cause the one or more processors to arbitrate access to at least one of the one or more first devices by at least one of the one or more second devices.

50. The bridge device of claim 49, wherein the program code to cause the one or more processors to arbitrate access to at least one of the one or more first devices comprises program code to cause the one or more processors to perform at least one of the following:
determine whether an interface to the at least one of the one or more first devices is available;
hold the network connections; and
close the network connections and force the second devices to retry.
